(19) United States
(12) Patent Application Publication
(10) Pub. No.: US 2021/0174373 A1
(43) Pub. Date: Jun. 10, 2021

(54) TICKET VALIDITY CONFIRMATION DEVICE, METHOD, AND PROGRAM

(71) Applicant: NEC Corporation, Minato-ku, Tokyo (JP)

(72) Inventor: Sanami NAKAGAWA, Tokyo (JP)

(73) Assignee: NEC Corporation, Minato-ku, Tokyo (JP)

(21) Appl. No.: 16/771,923

(22) PCT Filed: Dec. 14, 2017
(86) PCT No.: PCT/JP2017/044891

§ 371 Date: Jun. 11, 2020

(51) Int. Cl. G06Q 30/00; G06Q 20/04; G06Q 20/38; H04L 9/32

(52) U.S. Cl. CPC G06Q 30/018; H04L 9/3268; G06Q 20/38215; G06Q 20/045

(57) ABSTRACT

This ticket validity confirmation device prepares certificate data that is associated with one ticket and that comprises a set of certificate preparation information and certificate verification information, then stores the certificate verification information in a storage device, and transmits the certificate preparation information to a ticket information processing device. The ticket information processing device prepares a ticket validity certificate on the basis of the certificate preparation information, and transmits the ticket validity certificate to the ticket validity confirmation device. The ticket validity confirmation device verifies the ticket validity certificate on the basis of the certificate verification information stored in the storage device.

### TECHNICAL FIELD

This invention relates to confirmation of a validity of a ticket.

### BACKGROUND ART

In recent years, there has been a problem of illicit resale in which tickets for events, for example, popular live shows, are bought up for resale purposes and traded at high prices. There have been malicious cases in which several tens of millions of yen have been made through the buying up and resale of tickets, and arrests have been made.

As a measure to prevent such malicious illicit resales, resale itself may be prohibited, and the ticket may be printed by incorporating a digital watermark technology into a face photo on the ticket. In addition, confirmation of the identity, for example, face authentication, is performed, and whether or not the ticket has been resold is confirmed.

Although such illicit resales are taking place, there are reasonable social demands for people who can no longer go to an event to be able to resell their ticket at a fixed price to a person who wants to go to the event. In order to respond to those demands, it is required to establish a technology for supporting legitimate reselling.

There are ticket management systems that act as an intermediary, regardless of a paper ticket or an electronic ticket, between a party wanting to resell the ticket and a party wanting to purchase the ticket. In this type of ticket management system, the party wanting to resell registers the existence of the paper ticket that he or she wants to resell. The party wanting to purchase learns of this registration, and pays the price of the ticket to the ticket management system. When the payment is received, the ticket management system requests the party wanting to resell to send the ticket. When the ticket is received from the party wanting to resell, the ticket management system forwards the ticket to the party wanting to purchase. The party wanting to resell may also directly send the ticket to the resale purchaser. When the ticket does not arrive from such a party wanting to resell, the ticket management system refunds the party wanting to purchase. The reason for requesting the party wanting to resell to send the ticket is that it is difficult to revoke the ticket once the ticket has been issued. In particular, in the case of a paper ticket, revocation is difficult because it is impossible to update the data.

In this type of ticket management system, when a party wanting to purchase is not able to obtain the ticket, for example, in a case where the party wanting to resell neglects to send the ticket, a refund is given. However, in this case, the party wanting to purchase cannot obtain the desired ticket and thus cannot attend the event.

As a technology for legitimate resale, there is described in Patent Literature 1 a ticket system in which efficient cancellation of a purchased ticket can be performed by using a personal computer at home and a device having an image reading function and a printer function, for example, a so-called multifunction printer. Further, in Patent Literature 2, there is described a ticket system in which a ticket that has been issued can be returned to a state in which the ticket can be issued again.

In those methods, it is required that the ticket sales company, for example, know in advance information indicative of who has the ticket. For this reason, it is required that the tickets be sold by only one ticket sales company or that each company actually selling the tickets provide personal information on the parties wanting to resell.

### Citation List

### Patent Literature(s)

### PTL 1: JP 2002-329028 A

### PTL 2: JP 2017-182166 A

### SUMMARY OF INVENTION

### Technical Problem

As described above, there are ticket management systems that act as an intermediary between a party wanting to resell a paper ticket and a party wanting to purchase it. In this type of system, depending on the behavior of the party wanting to resell, the party wanting to purchase cannot obtain the desired paper ticket, and thus cannot attend the event.

When a ticket is directly sent from the party wanting to resell to the resale purchaser, it may be possible for the party wanting to resell and the resale purchaser to collude and make the resale appear to be legitimate in spite of the fact that this resale is an illicit resale at a high price. In such a method, the party wanting to resell and the resale purchaser conclude a resale contract via an illegitimate ticket management system, for example, and at that time the ticket is not yet sent. Next, the party wanting to resell performs ticket resale via the ticket management system performing resale at the proper price, and the resale purchaser purchases the ticket. Then, a large amount of money is paid at the illegitimate site. This allows the party wanting to resell to earn a lot of money, and allows the resale purchaser to perform a legitimate resale for the seat that he or she wants. This collusion problem may result in illicit resale becoming possible, despite the fact that the trading is made at a legitimate resale site.

This invention has been made in view of such a situation, and this invention is directed to solving a “problem in that a user may be denied entry despite he or she having purchased a resale ticket” and a “problem in that illicit resale may be possible at a legitimate resale site”, which are problems in existing ticket management systems. The method to be provided to solve those problems is to provide a ticket revocation function technology and a technology for confirming the validity of a ticket.

### Solution to Problem

In order to solve the above-mentioned problems, this invention provides, as an aspect thereof, a ticket validity confirmation device which comprises certificate data preparation means configured to prepare certificate data corresponding to one ticket, the certificate data comprising a set of certificate preparation information and certificate verification information; verification information storage means configured to store the certificate verification information therein; output means configured to externally output the certificate preparation information; and certificate verification means configured to verify, based on the certificate verification information stored in the verification information storage means, a ticket validity certificate prepared by another device based on the certificate preparation information.

In addition, this invention provides, as another aspect thereof, a ticket information processing device which comprises means configured to receive certificate preparation information of certificate data corresponding to one ticket prepared by a ticket validity confirmation device, the certificate data comprising a set of the certificate preparation information and certificate verification information; means configured to prepare a ticket validity certificate based on the certificate preparation information; and means configured to transmit the ticket validity certificate to the ticket validity confirmation device including a transmission source of the certificate preparation information, the ticket information processing device being configured to receive, from the ticket validity confirmation device including the transmission source of the certificate preparation information, verification of the ticket validity certificate based on the certificate verification information.

In addition, this invention provides, as another aspect thereof, a ticket validity confirmation system which comprises a ticket validity confirmation device; and a ticket information processing device, wherein the ticket validity confirmation device comprises: certificate data preparation means configured to prepare certificate data corresponding to one ticket, the certificate data comprising a set of certificate preparation information and certificate verification information; verification information storage means configured to store the certificate verification information therein; output means configured to output the certificate preparation information to the ticket information processing device serving as a destination; and certificate verification means configured to verify, based on the certificate verification information stored in the verification information storage means, a ticket validity certificate prepared by the ticket information processing device based on the certificate preparation information, wherein the ticket information processing device comprises means configured to receive the certificate preparation information of the certificate data corresponding to one ticket prepared by the ticket validity confirmation device, the certificate data comprising a set of the certificate preparation information and the certificate verification information; means configured to prepare the ticket validity certificate based on the certificate preparation information; and means configured to transmit the ticket validity certificate to the ticket validity confirmation device including a transmission source of the certificate preparation information.

In addition, this invention provides, as another aspect thereof, a method to be executed by a ticket validity confirmation device, the method comprising a certificate data preparation step of preparing certificate data corresponding to one ticket, the certificate data comprising a set of certificate preparation information and certificate verification information; a verification information storage step of storing the certificate verification information in a storage device; an output step of externally outputting the certificate preparation information; and a certificate verification step of verifying, based on the certificate verification information stored in the storage device, a ticket validity certificate prepared by another device based on the certificate preparation information.

In addition, this invention provides, as another aspect thereof, a method of confirming a validity of a ticket, the method comprising the steps of preparing, by a ticket validity confirmation device configured to confirm a validity of a ticket, certificate data corresponding to one ticket, the certificate data comprising a set of certificate preparation information and certificate verification information; storing, by the ticket validity confirmation device, the certificate verification information in a storage device; outputting the certificate preparation information from the ticket validity confirmation device to the ticket information processing device as a destination; receiving, by the ticket information processing device, the certificate preparation information; preparing, by the ticket information processing device, the ticket validity certificate based on the certificate preparation information; outputting, by the ticket information processing device, the ticket validity certificate to the ticket validity confirmation device as a destination; receiving, by the ticket validity confirmation device, the ticket validity certificate; and verifying, by the ticket validity confirmation device, the ticket validity certificate based on the certificate verification information stored in the storage device.

In addition, this invention provides, as another aspect thereof, a program for causing a computer to operate as certificate data preparation means for preparing certificate data corresponding to one ticket, the certificate data comprising a set of certificate preparation information and certificate verification information; verification information storage means for storing the certificate verification information therein; output means for externally outputting the certificate preparation information; and certificate verification means for verifying, based on the certificate verification information stored in the verification information storage means, a ticket validity certificate prepared by another device based on the certificate preparation information.

### Advantageous Effects of Invention

According to this invention, the validity of a ticket can be confirmed without using personal information on a party wanting to resell.

### BRIEF DESCRIPTION OF THE DRAWINGS

FIG. 1 is a block diagram of a ticket validity confirmation device 10 according to a first example embodiment of this invention.

FIG. 2 is a block diagram of a ticket information processing device 20.

FIG. 3 is a diagram for illustrating an operation of the ticket validity confirmation device 10 and the ticket information processing device 20.

FIG. 4 is a block diagram of a ticket validity confirmation device 30 according to a second example embodiment of this invention.

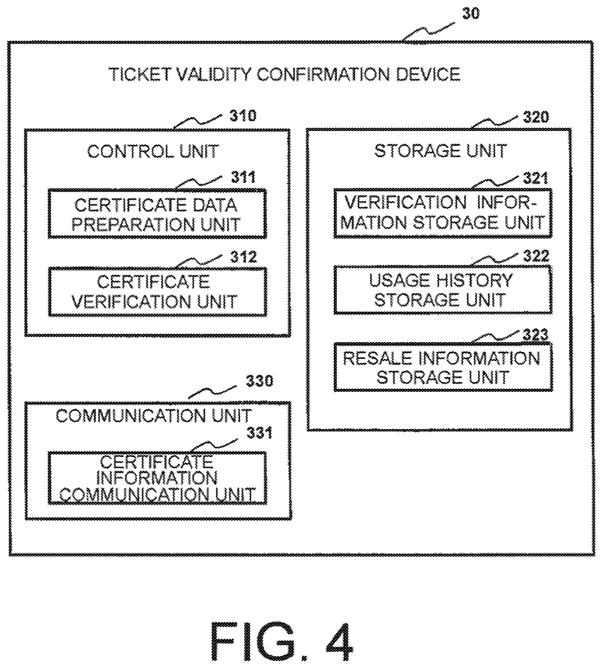

FIG. 5 is a diagram for illustrating an operation of the ticket validity confirmation device 30 and ticket information processing devices 20A and 20B.

FIG. 6 is a block diagram of a ticket validity confirmation device 50 according to a third example embodiment of this invention.

FIG. 7 is a block diagram of a ticket validity confirmation system in the third example embodiment.

FIG. 8 is a block diagram of an information sharing server 70 in the third example embodiment of this invention.

FIG. 9 is a diagram for illustrating an operation of the ticket validity confirmation system in the third embodiment of this invention.

FIG. 10 is a block diagram for illustrating a modification based on the ticket validity confirmation system in the third example embodiment of this invention.

### MODES FOR EMBODYING THE INVENTION

### First Example Embodiment

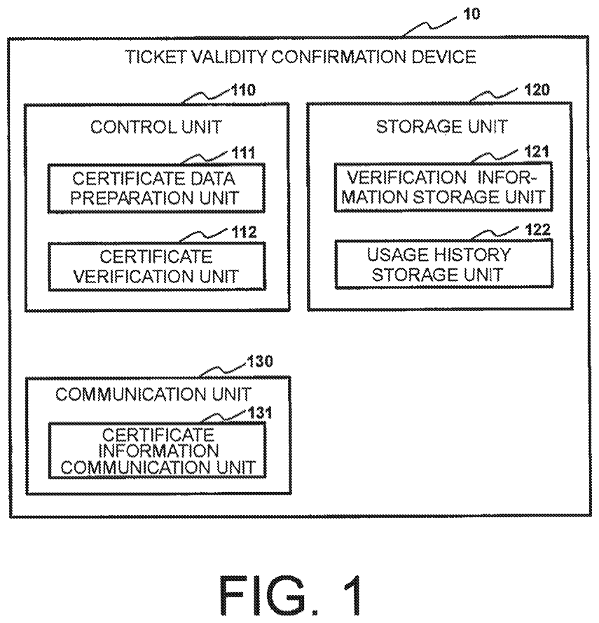

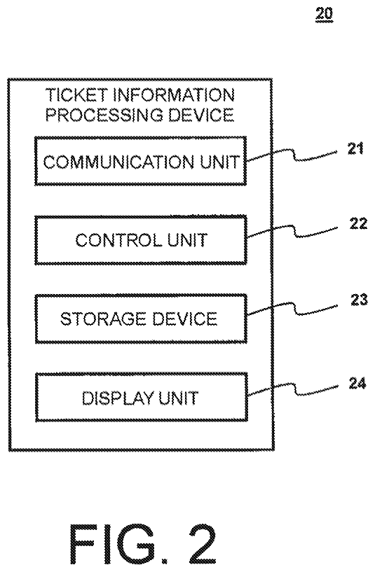

A first example embodiment of this invention is now described with reference to FIGS. 1 and 2. A ticket validity confirmation device 10 is a device for confirming the validity of an issued ticket. A user of the ticket validity confirmation device 10 is, for example, a person at a ticket company, or a person involved in an event for which the ticket is issued (a person in charge of entry into an event site).

The ticket validity confirmation device 10 includes a control unit 110, a storage unit 120, and a communication unit 130. Those units are each implemented by executing a program in a computer, such as a desktop computer, a laptop computer, a workstation, a tablet, or a smartphone.

The control unit 110 includes a certificate data preparation unit 111 and a certificate verification unit 112. The certificate data preparation unit 111 performs processing of preparing certificate data. The certificate data is data corresponding to one ticket. The certificate data includes a set of certificate preparation information and certificate verification information. The certificate preparation information and the certificate verification information are information used in a case where the ticket validity confirmation device 10 verifies a ticket validity certificate to be described later. The certificate verification unit 112 performs processing of verifying the ticket validity certificate based on the certificate verification information when a person who purchased a ticket (a ticket right holder) uses the ticket.

The certificate preparation information and the certificate verification information are a pair of pieces of information generated for each ticket. The certificate preparation information on each ticket is different from each other. Similarly, the certificate verification information on each ticket is different from each other. When, for example, the holder of the same ticket is changed, different certificate preparation information is generated, and different certificate verification information is generated. For example, a signature key of an electronic signature key pair may be used as the certificate preparation information, and a verification key of an electronic signature key pair may be used as the certificate verification information. An identifier capable of individually identifying the ticket is assigned to each ticket. This identifier and other information on tickets may be used to generate, even for the same ticket, different electronic signature key pairs different from other tickets based on time information on a time instant at which the electronic signature key pair is generated. When different electronic signature pairs exist for the same ticket, the electronic signature key pair that is currently valid can be identified based on the certificate verification information described in a ticket validity list to be described later.

The storage unit 120 includes a verification information storage unit 121 and a usage history storage unit 122. The verification information storage unit 121 stores a valid ticket list therein. The valid ticket list is a list for managing the certificate verification information to be used when verifying a ticket validity certificate. The usage history storage unit 122 stores, therein, usage history information, which is information indicating whether or not a ticket has been used.

The communication unit 130 includes a certificate information communication unit 131. The certificate information communication unit 131 is a communication device for performing communication with a ticket information processing device to be described later directly or via a communication network. A communication medium of the communication performed by the certificate information communication unit 131 may be wireless or wired. Terminal devices of a mobile communication network, for example, cell phones, may be connected to the ticket information processing device via the mobile communication network, or may be directly connected to the ticket information processing device via a universal serial bus (USB) cable or a wired local area network (LAN) cable. Those communication media may also be used in combination.

The certificate information communication unit 131 transmits certificate preparation information, for example, to be used during certificate verification to another computer, for example, the ticket information processing device. The certificate information communication unit 131 also receives a ticket validity certificate from another computer, for example—the ticket information processing device.

The ticket information processing device is a computer of a person who has purchased a ticket (ticket right holder). As illustrated in FIG. 2, the ticket information processing device includes a communication unit 21, a control unit 22, a storage device 23, and a display unit 24.

The communication unit 21 is a communication device for communicating with the certificate information communication unit 131 directly or via a communication network. The communication unit 21 may perform wireless communication or wired communication. The communication unit may be a terminal device of a mobile communication network, for example, a cell phone, or may be connected to the certificate information communication unit 131 via a universal serial bus (USB) cable or a wired LAN cable. The ticket information processing device is preferably a portable computer terminal, for example, a smartphone or a tablet.

The communication unit 21 receives the certificate preparation information from the certificate information communication unit 131. The communication unit 21 also transmits the ticket validity certificate to the certificate information communication unit 131.

The control unit 22 includes a processor, for example a central processing unit (CPU), which operates in accordance with programs. The control unit 22 controls an operation of each unit of the ticket information processing device 20 in accordance with programs stored in the storage device 23. The control unit 22 also prepares, in accordance with a program, a ticket validity certificate based on the certificate preparation information received by the communication unit 21. For example, an electronic signature signed by using the signature key of an electronic signature key pair, which is certificate preparation information, may be used as the ticket validity certificate.

The storage device 23 is a storage device. The storage device 23 stores programs for operating the control unit 22 therein. The storage device 23 stores at least any one of certificate preparation information received by the communication unit 21 and a ticket validity certificate prepared by the control unit 22.

The display unit 24 is a display device such as a liquid crystal display device or an organic electro-luminescence (EL) display device.

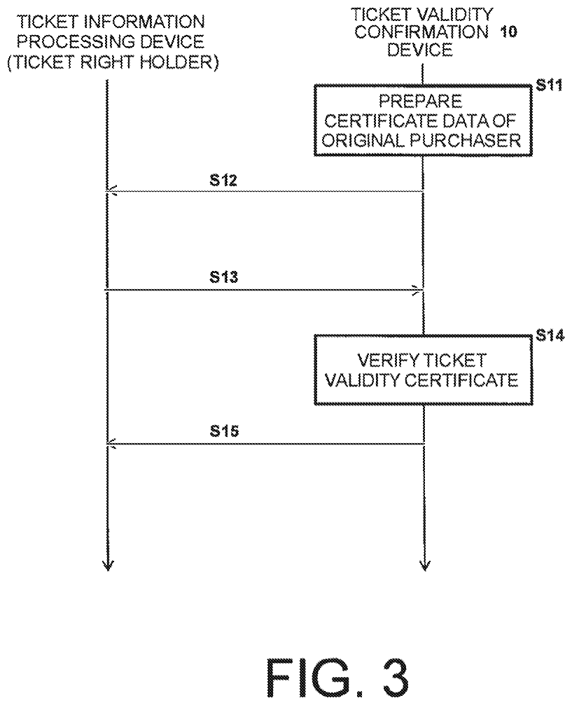

Next, an operation of the ticket validity confirmation device 10 until the person who purchased the ticket (ticket right holder) completes the use of the ticket will be described with reference to FIG. 3.

(Step 11) The ticket validity confirmation device 10 uses the certificate data preparation unit 111 to prepare certificate preparation information and certificate verification information. The certificate preparation information is information for preparing the ticket validity certificate information. The certificate verification information is information for verifying the ticket validity certificate information. At this time, the certificate data preparation unit 111 registers the certificate verification information in the valid ticket list of the verification information storage unit 121. When there are a plurality of tickets, a ticket ID (identifyer) capable of uniquely specifying the ticket and the certificate verification information on the ticket are registered in the valid ticket list.

(Step 12) The ticket validity confirmation device 10 uses the certificate information communication unit 131 to transmit the certificate preparation information to the ticket information processing device 20 of the ticket right holder. The transmission method may be performed by directly linking the ticket validity confirmation device 10 and the ticket information processing device 20 by a USB cable or the like, or by performing wireless communication via a mobile communication network. The certificate preparation information may also be transmitted via a computer of an intermediary, for example, the ticket company. When a ticket ID has been assigned to the ticket relating to the certificate preparation information to be transmitted, the certificate preparation information is transmitted together with the ticket ID. In response to this, the ticket information processing device 20 receives the certificate preparation information at the communication unit 21. The ticket information processing device 20 stores the received certificate preparation information in the storage device 23.

(Step 13) When the ticket right holder uses a ticket, for example, on entering an event, the ticket right holder performs a predetermined operation for instructing the ticket information processing device 20 to transmit the ticket validity certificate. The control unit 22 reads the certificate preparation information from the storage device 23 and prepares the ticket validity certificate. The communication unit 21 transmits the prepared ticket validity certificate to the ticket validity confirmation device 10.

(Step 14) The ticket validity confirmation device 10 uses the certificate information communication unit 131 to receive the ticket validity certificate from the ticket information processing device 20. The ticket validity confirmation device 10 verifies the received ticket validity certificate based on the certificate verification information registered in the valid ticket list of the verification information storage unit 121 in the step 11.

(Step 15) The ticket validity confirmation device 10 determines whether the ticket is valid or invalid based on the verified result of the step 14. The certificate information communication unit 131 transmits the determined result to the ticket information processing device 20. In response to reception of the determined result, the display unit 24 displays a message indicative of the determined result. The ticket right holder sees this message and can confirm that the ticket is valid. When the ticket is valid, the usage history storage unit 122 records that the ticket is in a used state as usage history information.

The ticket validity confirmation device 10 may also display the determined result by outputting the determined result to a display device (not shown). When the ticket is valid, the ticket validity confirmation device 10 displays a message indicating that the ticket is valid on a liquid crystal display device, for example. A person involved with the event, for example, sees the message and permits the ticket right holder to exercise the right of the ticket. Meanwhile, when the ticket is invalid, the ticket validity confirmation device 10 displays a message indicating that the ticket is invalid on the liquid crystal display device, for example. A person involved with the event, for example, sees the message and does not permit use of the ticket.

According to this example embodiment, the user of the ticket validity confirmation device 10 can confirm the validity of a ticket by using the ticket validity certificate and the valid ticket list. Therefore, the user of the ticket validity confirmation device 10 can confirm whether or not the user of the ticket information processing device 20 is the genuine right holder.

### Second Example Embodiment

A second example embodiment of this invention will be now described. A ticket validity confirmation device 30 is implemented by, for example, executing programs in a computer such as a desktop computer, a laptop computer, a workstation, a tablet, or a smartphone. The user of the ticket validity confirmation device 30 is, for example, a person at the ticket company, or a person involved in the event for which the ticket is issued (a person in charge of entry into the event site). The ticket validity confirmation device 30 includes a control unit 310, a storage unit 320, and a communication unit 330.

The control unit 310 has the same function as that of the control unit 110 of the ticket validity confirmation device 10. A certificate data preparation unit 311 and a certificate verification unit 312 have the same functions as those of the certificate data preparation unit 111 and the certificate verification unit 112, respectively.

The storage unit 320 is a storage device. The storage unit 320 includes a verification information storage unit 321, a usage history storage unit 322, and a resale information storage unit 333. The verification information storage unit 321 stores a valid ticket list therein. The valid ticket list is a list for managing the certificate verification information to be used when the ticket validity certificate is verified. The usage history storage unit 322 records a usage state of the ticket as usage history information therein. The resale information storage unit 333 stores a resale state therein. The resale state indicates a resale-related state of the ticket, for example, a state in which the purchaser of the ticket wants to resell and a resale destination party has not yet been determined.

The communication unit 330 includes a certificate information communication unit 331. The certificate information communication unit 331 has the same function as that of the certificate information communication unit 131 of the ticket validity confirmation device 10.

Next, an operation of the ticket validity confirmation device 30 will be described. Before the operation is described, definitions of terms are provided. A person who first genuinely purchased a ticket and wants to resell the ticket is referred to as an “original purchaser”. A person wanting to purchase the ticket to be resold by the original purchaser is referred to as a “resale destination party”.

The original purchaser and the resale destination party each have a ticket information processing device 20. In order to distinguish the original purchaser and the resale destination party from each other, the ticket information processing device 20 of the original purchaser is referred to as a “ticket information processing device 20A” and the ticket information processing device 20 of the resale destination party is referred to as a “ticket information processing device 20B”. The communication unit 21, the control unit 22, the storage device 23, and the display unit 24 of the ticket information processing devices 20A and 20B are also distinguished by adding “A” or “B” at the end of the reference numerals.

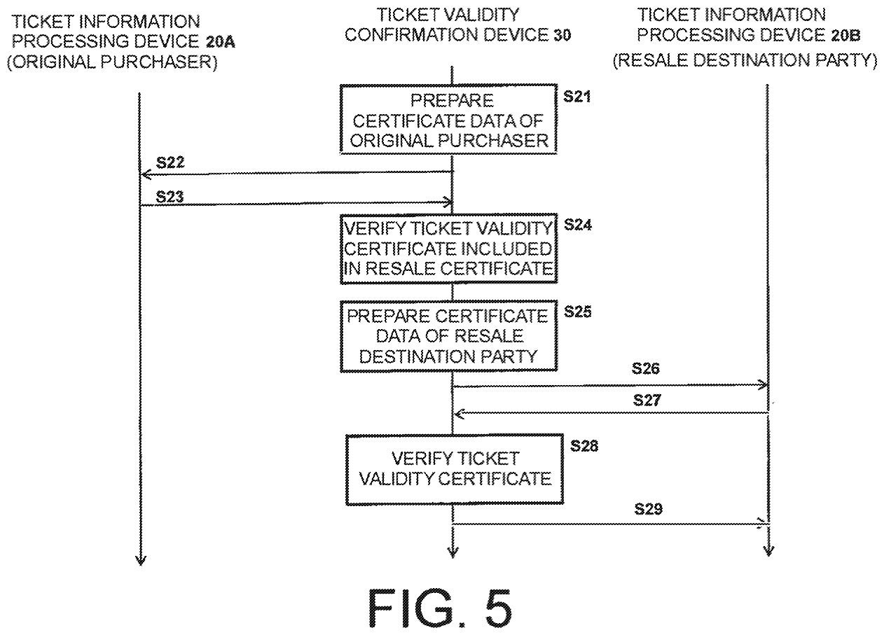

There is now given a description with reference to FIG. 5.

(Step 21) The ticket validity confirmation device 30 uses the certificate data preparation unit 311 to prepare certificate preparation information and certificate verification information. The certificate preparation information is information for preparing the ticket validity certificate information. The certificate verification information is information for verifying the ticket validity certificate information. At this time, the certificate data preparation unit 311 registers the certificate verification information in the valid ticket list of the verification information storage unit 321. When there are a plurality of tickets, the certificate verification information is registered together with a ticket ID (identifier) capable of uniquely determining the ticket.

The certificate preparation information and the certificate verification information are a pair of pieces of information generated for each ticket. The certificate preparation information on each ticket is different from each other. Similarly, the certificate verification information on each ticket is different from each other. When, for example, the holder of the same ticket is changed, different certificate preparation information is generated, and different certificate verification information is generated. For example, a signature key of an electronic signature key pair may be used as the certificate preparation information, and a verification key of the electronic signature key pair may be used as the certificate verification information. An identifier capable of individually identifying the ticket is assigned to each ticket. This identifier and other information on tickets may be used to generate, even for the same ticket, different electronic signature key pairs different from other tickets based on time information on a time instant at which the electronic signature key pair is generated.

(Step 22) The ticket validity confirmation device 30 uses the certificate information communication unit 331 to transmit the certificate preparation information to the ticket information processing device 20A of the original purchaser. The transmission method may be performed by directly linking the ticket validity confirmation device 30 and the ticket information processing device 20A by a USB cable or the like, or by performing wireless communication via a mobile communication network. The certificate preparation information may also be transmitted via a computer of an intermediary, for example, the ticket company. When a ticket ID has been assigned to the ticket relating to the certificate preparation information to be transmitted, the certificate preparation information is transmitted together with the ticket ID. In response to this, the ticket information processing device 20A receives the certificate preparation information at the communication unit 21A. The ticket information processing device 20A stores the received certificate preparation information in the storage device 23A.

(Step 23) It is assumed here that the original purchaser has requested to resell the ticket. In this case, the original purchaser transmits a resale certificate from the ticket information processing device 20A to the ticket validity confirmation device 30. The resale certificate is information including the ticket validity certificate described in the first example embodiment and an indication of intent to resell. The indication of intent to resell is information for tifying the user of the ticket validity confirmation device 30 (a person involved with the event) of the fact that the original purchaser, who is the user of the ticket information processing device 20A, intends to resell the ticket.

That is, the control unit 22A generates the indication of intent to resell in response to an operation by the original purchaser. In response to the operation by the original purchaser, the control unit 22A reads, from the storage device 23A, the certificate preparation information stored in the step 22. The control unit 22A prepares the ticket validity certificate based on the read certificate preparation information. The control unit 22A generates the resale certificate based on the indication of intent to resell and the ticket validity certificate. The communication unit 21A transmits the generated resale certificate to the ticket validity confirmation device 30.

(Step 24) In the ticket validity confirmation device 30, the certificate verification unit 312 verifies the ticket validity certificate included in the received resale certificate. The verification is performed by using the certificate verification information registered in the valid ticket list of the verification information storage unit 321 in the step 21. When the ticket validity certificate is verified to be valid, the certificate verification unit 312 determines that the resale certificate is valid, and records a resale state in the resale information storage unit 323. The resale state recorded in this step indicates the state after the user of the ticket information processing device 20 has indicated that he or she wants to resell the ticket, and the resale destination party is yet to be determined. This state is referred to as a “want-to-resell” state.

When there is a ticket recorded in the want-to-resell state in the resale information storage unit 323, the user of the ticket validity confirmation device 30 notifies that the ticket is for sale and invites parties wanting to purchase. Various invitation methods may be used, and the particular method is not specified.

(Step 25) When a resale destination party, which is a party wanting to purchase the ticket, is found, in the ticket validity confirmation device 30, the certificate data preparation unit 311 generates the certificate preparation information and certificate verification information on the resale destination party.

Even when the certificate preparation information and the certificate verification information have been prepared based on the same ticket ID, because time has elapsed from the step 21, those different from the certificate preparation information and certificate verification information prepared in the step 21 can be generated.

The certificate preparation information on the resale destination party is information used to prove the validity of the ticket on using the ticket by the resale destination party. The certificate verification information on the resale destination party is used on verifying, by the ticket validity confirmation device 30, the ticket validity certificate prepared based on the certificate preparation information on the resale destination party. The verification information storage unit 321 stores the certificate verification information on the resale destination party in the valid ticket list.

On registering the certificate verification information on the resale destination party in the valid ticket list, the verification information storage unit 321 may delete the certificate verification information on the original purchaser associated with the same ticket ID already registered in the valid ticket list. In this case, it is assumed that valid certificate verification information on a certain ticket ID is actually registered in the verification information storage unit 321.

Alternatively, the verification information storage unit 321 may also be configured to only register certificate verification information in the valid ticket list, and not to in principle delete certificate verification information. In this case, on registering the certificate verification information in the valid ticket list, the verification information storage unit 321 registers time information (registration time information) indicative of a time instant of registration in association with the certificate verification information. In this case, of pieces of the certificate verification information currently registered in the verification information storage unit 321, the valid certificate verification information on a certain ticket ID is only the certificate verification information having the latest registration time information. Certificate verification information having old registration time information is treated as being invalid.

(Step 26) In the ticket validity confirmation device 30, the certificate information communication unit 331 transmits the certificate preparation information on the resale destination party generated in the step 25 to the ticket information processing device 20B of the resale destination party. In accordance with this transmission, the communication unit 21B of the ticket information processing device 20B receives the certificate preparation information on the resale destination party.

(Step 27) In the ticket information processing device 20B, the control unit 22B generates a ticket validity certificate based on the certificate preparation information received in the step 26. The communication unit 21B transmits the generated ticket validity certificate to the ticket validity confirmation device 30. In accordance with this transmission, the certificate information communication unit 331 of the ticket validity confirmation device 30 receives the ticket validity certificate.

(Step 28) In the ticket validity confirmation device 30, the certificate verification unit 312 verifies, based on the certificate verification information stored in the valid ticket list of the verification information storage unit 321 in the step 25, the ticket validity certificate received from the ticket information processing device 20B in the step 27.

(Step 29) In the ticket validity confirmation device 30, the certificate verification unit 312 determines whether or not the ticket is usable based on the verified result of the ticket validity certificate of the resale destination party. The certificate information communication unit 331 transmits the determined result to the ticket information processing device 20. In response of reception of the determined result, the display unit 24B displays a message indicative of the determined result. The ticket right holder sees this message and can confirm that the ticket is valid. When the ticket is valid, the usage history storage unit 122 records, as usage history information, that the ticket is in a used state.

The ticket validity confirmation device 30 may also output the determined result to a display device (not shown) to display the determined result thereon. When the ticket is valid, the ticket validity confirmation device 30 displays a message indicating that the ticket is valid on a liquid crystal display device, for example. A person involved with the event, for example, sees the message and permits the ticket right holder to exercise the right of the ticket. For example, entry to the event site with the ticket is permitted. Meanwhile, when the ticket is invalid, the ticket validity confirmation device 30 displays, for example, on the liquid crystal display device, a message indicating that the ticket is invalid. A person involved with the event, for example, sees the message and does not permit the ticket right to be exercised. For example, entry to the event site with the ticket is not permitted.

The resale destination party who has obtained the ticket may also want to resell before using the ticket at the event. In this case, by repeating the steps 23 to 26 from the standpoint of the original purchaser, it is possible for the resale destination party to again resell the ticket obtained by resale. Through repetition of those steps, the same ticket can be resold by three or more people one after the other like a human chain.

According to this example embodiment, the validity of a ticket can be confirmed based on the ticket valid certificate and the valid ticket list. For this reason, even when the ticket is resold, it is possible to confirm whether the person who can properly exercise the right of a certain ticket is the original purchaser or a resale destination party.

### Third Example Embodiment

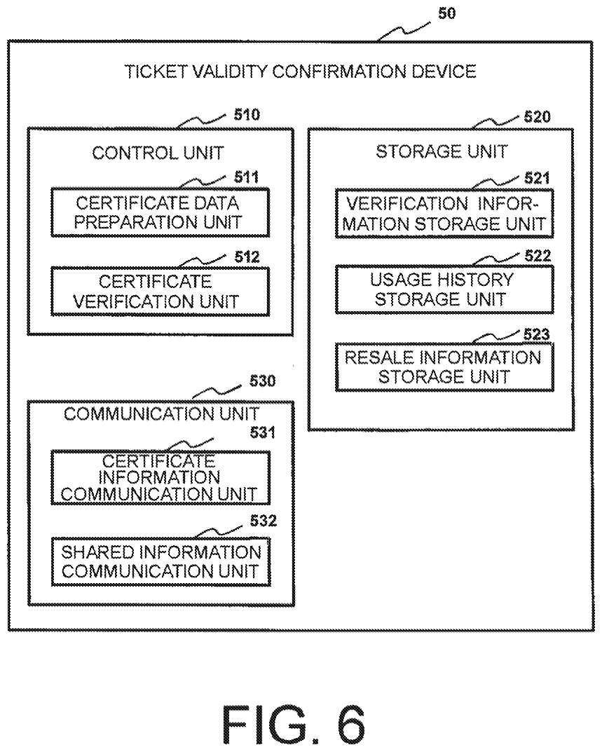

A third example embodiment of this invention will be now described. Referring to FIG. 6, a ticket validity confirmation device 50 includes a control unit 510, a storage unit 520, and a communication unit 530. The control unit 510 and the storage unit 520 are the same as the control unit 310 and the storage unit 320 of the ticket validity confirmation device 30, respectively. The communication unit 530 includes a certificate information communication unit 531 and a shared information communication unit 532. The certificate information communication unit 531 communicates with the ticket information processing device 20. The shared information communication unit 532 communicates with an information sharing server 70.

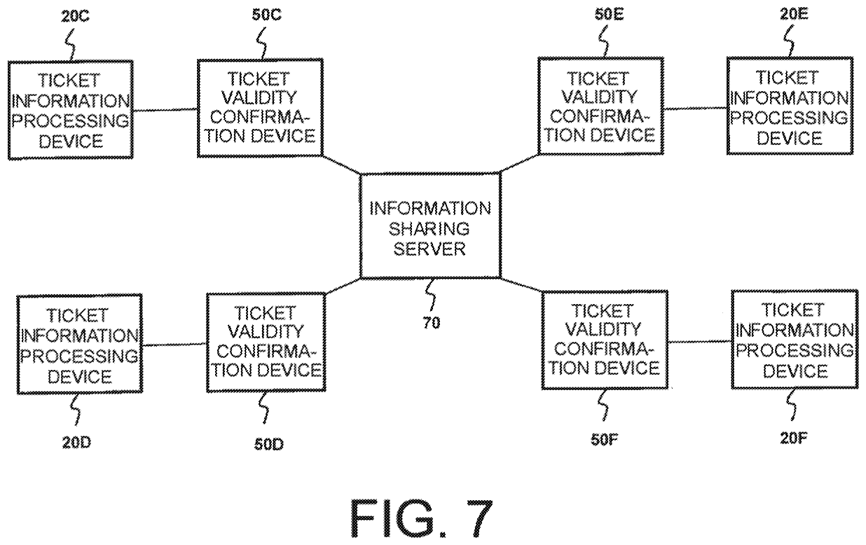

It is assumed that the ticket validity confirmation device 50 is possessed by each ticket company selling and reselling tickets and all related companies, for example, event companies involved with entry on holding an event. In this example, it is assumed that there are four related companies, namely, Company C, Company D, Company E, and Company F. In order to distinguish the ticket validity confirmation devices 50 of those four companies from each other, as illustrated in FIG. 7, a letter “C” to “F” is added to the end of the reference numerals. The same applies to the reference numerals of the respective units of the ticket validity confirmation devices 50C to 50F.

Each of the ticket validity confirmation devices 50C to 50F is connected to the information sharing server 70 via a data communication line. The type of data communication line is not particularly limited. A representative example of the data communication line is the Internet, but a dedicated data communication network may be laid to connect the ticket validity confirmation devices 50C to 50F to each other. The information sharing server 70 is a server for sharing the certificate verification information and the usage history information among the ticket validity confirmation devices 50C to 50F.

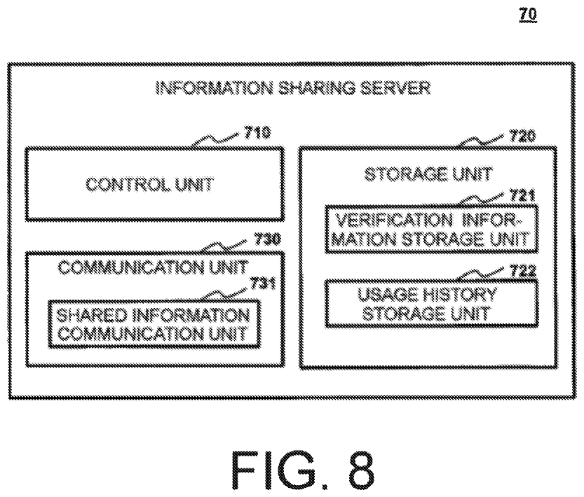

As illustrated in FIG. 8, the information sharing server 70 includes a control unit 710, a storage unit 720, and a communication unit 730. The control unit 710 includes a processor and controls each unit of the information sharing server 70. The storage unit 720 includes a storage device. The storage unit 720 includes a verification information storage unit 721 and a usage history storage unit 722. The verification information storage unit 721 stores, therein, certificate verification information received from each of the ticket validity confirmation devices 50C to 50F The usage history storage unit 722 stores, therein, usage history information received from each of the ticket validity confirmation devices 50C to 50F The communication unit 730 is a data communication device, for example, a network interface card. The communication unit 730 includes a shared information communication unit 731. The shared information communication unit 731 performs data communication with the ticket information processing devices 20C to 20F and with the ticket validity confirmation devices 50C to 50F to transmit and receive certificate verification information, usage history information, and the like.

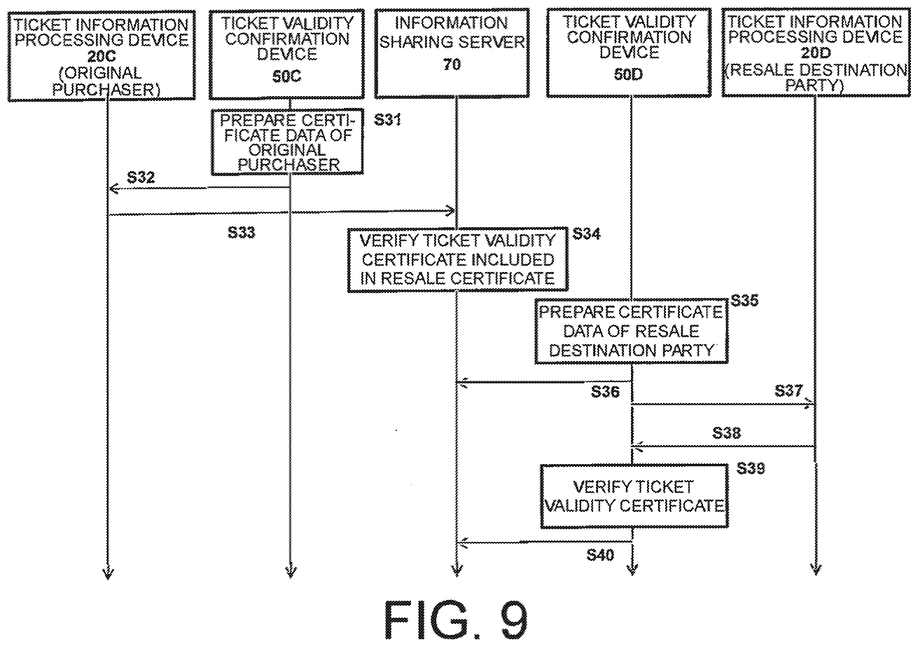

A person buying a ticket from or selling a ticket to Company C connects his or her ticket information processing device 20 to the ticket validity confirmation device 50C. A ticket information processing device 20 connected to the ticket validity confirmation device 50C is referred to as a “ticket information processing device 20C”. The user of the ticket information processing device 20C is referred to as a “user C”. The same applies to the ticket information processing devices 20D to 20F and their users. A process in which a ticket purchased by the user C is resold to the user D will be now described with reference to FIG. 9.

(Step 31) The ticket validity confirmation device 50C uses the certificate data preparation unit 511C to prepare certificate preparation information and certificate verification information. The certificate preparation information is information for preparing the ticket validity certificate information. The certificate verification information is information for verifying the ticket validity certificate information. At this time, the certificate data preparation unit 511C registers the certificate verification information in the valid ticket list of the verification information storage unit 521C. When there are a plurality of tickets, the certificate verification information is registered together with a ticket ID (identifyer) capable of uniquely determining the ticket. At this time, the shared information communication unit 532C transmits the certificate verification information to the information sharing server 70. In accordance with this transmission, in the information sharing server 70, the shared information communication unit 731 receives the certificate verification information. The verification information storage unit 721 stores the received certificate verification information therein.

Similarly, each of the ticket validity confirmation devices 50D to 50F prepares certificate preparation information and certificate verification information. The ticket validity confirmation devices 50D to 50F transmit relevant pieces of certificate preparation information to the corresponding ticket information processing devices 20D to 20F, respectively. The ticket validity confirmation devices 50D to 50F register the relevant pieces of certificate verification information in the valid ticket lists of the corresponding verification information storage units 521D to 521F, respectively. The ticket validity confirmation devices 50D to 50F transmit the relevant piece of certificate verification information to the information sharing server 70, respectively. In the information sharing server 70, those pieces of certificate verification information are received by the shared information communication unit 731 and stored in the verification information storage unit 721.

The certificate preparation information and the certificate verification information are a pair of pieces of information generated for each ticket. The certificate preparation information on each ticket is different from each other. Similarly, the certificate verification information on each ticket is different from each other. Further, for the same ticket, different certificate preparation information is generated, and different certificate verification information is generated. For example, a signature key of an electronic signature key pair may be used as the certificate preparation information, and a verification key of the electronic signature key pair may be used as the certificate verification information. An identifier capable of individually identifying the ticket is assigned to each ticket. Even for the same ticket, different electronic signature key pairs different from other tickets can be generated based on this identifier and time information on a time instant at which the electronic signature key pair is generated.

(Step 32) The ticket validity confirmation device 50C uses the certificate information communication unit 531C to transmit the certificate preparation information to the ticket information processing device 20C of the original purchaser. The transmission method may be performed by directly linking the ticket validity confirmation device 50C and the ticket information processing device 20C by a USB cable or the like, or by performing wireless communication via a mobile communication network. The certificate preparation information may also be transmitted via a computer of an intermediary, for example, the ticket company. When a ticket ID has been assigned to the ticket relating to the certificate preparation information to be transmitted, the certificate preparation information is transmitted together with the ticket ID. In response to this, the ticket information processing device 20C receives the certificate preparation information at the communication unit 21C. The ticket information processing device 20C stores the received certificate preparation information in the storage device 23C. The ticket validity confirmation devices 50D to 50F and the ticket information processing devices 20D to 20F operate in a similar manner.

(Step 33) It is assumed that the user of the ticket information processing device 20C is the original purchaser. At this time, in the ticket information processing device 20C, the control unit 22C generates a resale certificate including the ticket validity certificate based on the certificate preparation information received in the step 32. The communication unit 21C transmits the resale certificate to the information sharing server 70. This transmission method may be performed by connecting the ticket information processing device 20C and the information sharing server 70 in a one-to-one manner by a data communication line. The resale certificate may also be transmitted to the information sharing server 70 via another computer including the ticket validity confirmation device 50C, for example. In the information sharing server 70, the shared information communication unit 731 receives the resale certificate. The control unit 710 stores the ticket validity certificate included in the resale certificate in the verification information storage unit 721.

(Step 34) In the ticket validity confirmation devices 50C to 50F, the certificate verification units 512C to 512F verify, based on the certificate verification information, the ticket validity certificates stored in the information sharing server 70 in the step 33, respectively. The certificate verification information used at this time is, among pieces of certificate verification information stored in the verification information storage unit 721 of the information sharing server 70 in the step 31, the certificate verification information transmitted from the ticket information processing device 20C of the user, who is the seller. When it is verified that the ticket validity certificate is correct, the resale information storage units 523C to 523F record the resale state in the ticket validity confirmation devices 50C to 50F, respectively. The resale state recorded in this step is the state after the user C of the ticket information processing device 20C has indicated that he or she wants to resell the ticket, and the resale destination party is yet to be determined. That is, a want-to-resell state is stored therein.

When there is a ticket recorded in the want-to-resell state in the resale information storage units 523C to 523F, the companies C to F notify that the ticket is for sale and invite parties wanting to purchase. Various invitation methods may be used, and the particular method is not specified.

(Step 35) As illustrated in FIG. 7, the ticket validity confirmation devices 50C to 50F of companies C to F are sharing information via the information sharing server 70. It is assumed that the user D, who is the person performing business with the company D, of the ticket information processing device 20D has become the resale destination party. At this time, in the ticket validity confirmation device 50D connected to the ticket information processing device 20D, the certificate data preparation unit 511D prepares the certificate preparation information and the certificate verification information.

The certificate preparation information and the certificate verification information generated herein are a pair of pieces of information generated for each ticket. The target ticket and the ticket ID thereof are the same as in the step 31, but because the generated time instants are different from each other, the certificate preparation information and the certificate verification information generated herein are different from those in the step 31.

The certificate preparation information prepared by the certificate data preparation unit 511D is used for preparing the ticket validity certificate in the ticket information processing device 20D of the user D, who is the resale destination party. As described later, the ticket validity certificate is used for confirming the validity of the ticket when the user D enters the event site.

The certificate verification information prepared by the certificate data preparation unit 511D is information paired with the certificate preparation information. The certificate verification information is used on verifying the ticket validity certificate prepared based on the paired certificate preparation information.

(Step 36) Subsequently, in the ticket validity confirmation device 50D, the shared information communication unit 532D transmits the certificate verification information prepared in the step 35 to the information sharing server 70.

In the information sharing server 70, the shared information communication unit 731 receives the certificate verification information. The verification information storage unit 721 stores the received certificate verification information in the valid ticket list.

(Step 37) Then, in the ticket validity confirmation device 50D, the certificate information communication unit 531 transmits the certificate preparation information prepared in the step 35 to the ticket information processing device 20D.

In the ticket information processing device 20D, the communication unit 21D receives the certificate preparation information. The storage device 23 stores the received certificate preparation information therein.

(Step 38) When the user D, who is the resale destination party, uses the ticket, in the ticket information processing device 20D, the control unit 22D prepares a ticket validity certificate based on the certificate preparation information stored in the storage device 23D. The communication unit 21D transmits the ticket validity certificate to the ticket validity confirmation device 50D. In the ticket validity confirmation device 50D, the certificate information communication unit 531D receives the ticket validity certificate.

(Step 39) In the ticket validity confirmation device 50D, the certificate verification unit 512D verifies, based on the certificate verification information, the ticket validity certificate received in the step 38. The certificate verification information used herein is the certificate verification information stored in the step 36 in the valid ticket list in the verification information storage unit 721 of the information sharing server 70. In the case of this combination of the ticket validity certificate and the certificate verification information, the ticket validity certificate is verified to be valid. When the combination of the ticket validity certificate and the certificate verification information is incorrect, the ticket validity certificate is verified to be invalid, and the operation is halted.

In the ticket validity confirmation device 50D, the certificate verification unit 512D determines, based on the verified result of the ticket validity certificate performed in the step 39, whether or not the user D can use the ticket.

When the ticket validity certificate is valid, the certificate verification unit 512D permits use of the ticket. In accordance with this permission, the control unit 510D displays, from an output device, for example, a display device, a message indicative of the effect that use of the ticket is permitted. A person involved with the event, for example, sees the message and permits the user D to enter the event site. At this time, the certificate information communication unit 531D may also transmit, to the ticket information processing device 20D, the message indicative of the effect that use of the ticket is permitted.

Meanwhile, when the ticket validity certificate is invalid, the certificate verification unit 512D prohibits use of the ticket. The control unit 510D displays, from the output device, for example, the display device, a message indicative of the effect that use of the ticket is prohibited. A person involved with the event, for example, sees the message and prohibits the user D from entering the event site. At this time, the certificate information communication unit 531D may also transmit, to the ticket information processing device 20D, the message indicative of the effect that use of the ticket is prohibited.

(Step 40) When the ticket validity certificate is valid, in the ticket validity confirmation device 50D, the shared information communication unit 532D transmits, to the information sharing server 70, usage history information indicating that the ticket is in a used state. In the information sharing server 70, the shared information communication unit 731 receives the usage history information. The usage history storage unit 722 records the received usage history information therein.

The resale destination party who has obtained the ticket may also want to resell before using the ticket at the event. In this case, by repeating the steps 33 to 37 from the standpoint of the original purchaser, it is possible for the resale destination party to again resell the ticket obtained by resale. Through repetition of those steps, the same ticket can be resold by three or more people one after the other like a human chain.

According to this example embodiment, the validity of a ticket can be confirmed based on the ticket valid certificate and the valid ticket list. For this reason, even when the ticket is resold, it is possible to confirm whether the person who can properly exercise the right of a certain ticket is the original purchaser or a resale destination party.

Further, according to this example embodiment, a plurality of companies can verify the validity of ticket validity via the information sharing server 70. Therefore, even when the ticket is resold between parties who purchased the ticket from different ticket companies, it is possible to maintain the consistency of the ticket right before and after resale.

[Modification]

Next, operations of embodiments for implementing this invention will be described by using more specific examples. In the following modification, a signature key of an electronic signature key pair is used as the certificate preparation information in the above-mentioned example embodiments. Similarly, a verification key of the electronic signature key pair is used as the certificate verification information. An electronic signature signed with the signature key of the electronic signature key pair is used as the ticket validity certificate. The valid ticket list is held on a blockchain.

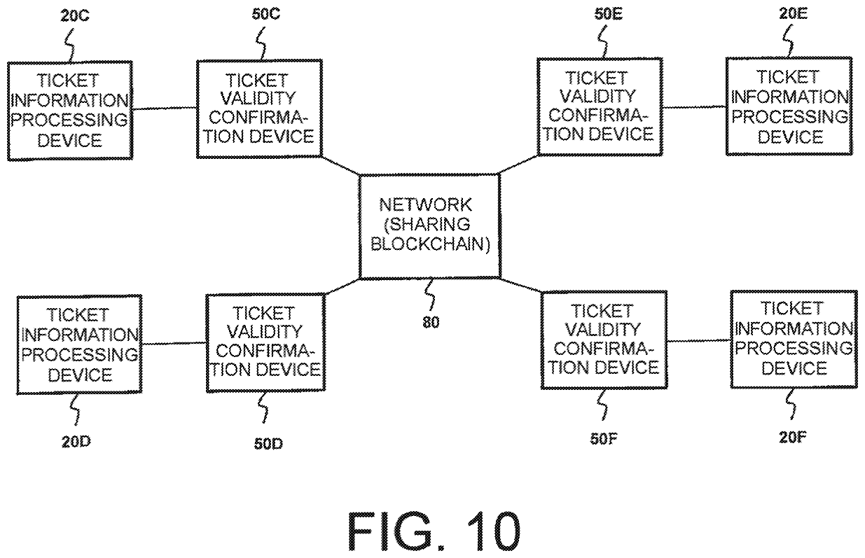

In the third example embodiment, the valid ticket list is held in the information sharing server 70. In this modification, in place of a specific server holding the valid ticket list, a distributed ledger technology is used to hold the valid ticket list (certificate verification information) as a blockchain. That is, as illustrated in FIG. 10, in this modification, the ticket companies and the like involved in the resale of tickets each prepares a ticket validity confirmation device 50. The blockchain is held among the plurality of ticket validity confirmation devices 50.

<Before Ticket Sale>

As illustrated in FIG. 10, ticket companies that sell tickets, resale sites that handle the reselling of tickets, and event companies that manage entry prepare the ticket validity confirmation devices 50, respectively. Those ticket validity confirmation devices 50 are connected to each other via a data communication network, for example, the Internet.

In this modification, in place of the information sharing server 70 in the third example embodiment, information is shared by using the blockchain. Therefore, it is not required to manage the information sharing server 70. Further, there is no risk that the information held in the information sharing server 70 is tampered with by, for example, an administrator of the information sharing server 70.

Information on the ticket is described in the blockchain. The information on the ticket includes, for example, a ticket ID, seat information, and a ticket sales company.

The ticket ID is an identifier for individually identifying the ticket on the blockchain. The ticket ID is stored in the valid ticket list in association with the certificate verification information on the ticket, and is also used for managing the certificate verification information in the valid ticket list. The ticket ID may be generated based on, for example, a combination of event information (for example, event name, date and time of the event, and site name) and seat information.

The seat information is information for identifying the seat assigned to the purchaser of the ticket at the event site. The ticket sales company is the name of the company selling the ticket.

As illustrated in FIG. 10, the blockchain is shared among the ticket validity confirmation devices 50C to 50F of the companies C to F via a network 80.

An operation of the ticket validity confirmation devices 50 in a situation like described below will now be described. The company C, which is the ticket sales company, sells a ticket T to the user C of the ticket information processing device 20C. The user C resells the ticket T to the user D of the ticket information processing device 20D via a legitimate resale site operated by the company D. The user D enters the event site by using the ticket T.

<During Sale>

When a person in charge at the company C sells the ticket T to the user C, the ticket validity confirmation device 50C generates the certificate preparation information and the certificate verification information for the ticket T. In this modification, the certificate preparation information is a signature key sk_1 of the electronic signature key pair, and the certificate verification information is a verification key vk_1 of the electronic signature key pair. The electronic signature key pair including the signature key and the verification key is generated for each ticket ID. A different electronic signature key pair is generated for each ticket ID. The signature key sk_1 is used when the user enters the event site by using the ticket T or when the user resells the ticket T. An electronic signature σ_1 is generated as the ticket validity certificate by using the signature key sk_1.

The company C delivers the ticket ID and the signature key sk_1 to the user C, who is the original purchaser. The delivery method may be any method as long as the signature key sk_1 becomes usable.

For example, the ticket validity confirmation device 50C and the ticket information processing device 20C may both include a USB port or a LAN port, and those ports may be connected via a cable such as a USB cable or a LAN cable to perform data transfer. As another example, the ticket information processing device 20C may include a non-contact type IC card, for example, Felica, a non-contact type IC card reader/writer device may be connected to the corresponding ticket validity confirmation device 50C, and short-range wireless communication may be performed between the two devices to perform data transfer. As another example, data transfer may be performed via a wireless LAN or a cell phone network. Further, a paper ticket on which the ticket ID and the signature key sk_1 are printed may be delivered to the user C.

The ticket validity confirmation device 50C of the company C records the ticket ID and the verification key vk_1 in the valid ticket list on the blockchain in association with each other. If the information on the verification key is freely rewritten, the information to be used during entry can be easily changed. In view of this, it is preferred that access to the valid ticket list be restricted. For example, an access right permitting rewriting of the information on the tickets in the valid ticket list may be given to, for example, the ticket holder or the ticket sales company selling the ticket to the ticket holder. At a time instant when a ticket is sold, the right to write the ticket ID of the ticket is given to the company C, which is the ticket sales company selling the ticket.

In this way, when the valid ticket list on the blockchain is updated, the ticket validity confirmation device 50C uses the shared information communication unit 532C to transmit the updated blockchain to the ticket validity confirmation devices 50D to 50F The ticket validity confirmation devices 50D to 50F receive the updated blockchain via the shared information communication units 532D to 532F, respectively. Hereinafter, on subsequently validating the ticket validity certificates in the ticket validity confirmation devices 50C to 50F, the certificate verification units 512C to 512F perform verification based on the updated valid ticket list on the updated blockchain, respectively.

<During Resale>

It is assumed that the user C, who is the original purchaser, wants to resell the ticket T. At this time, the user C uses the ticket information processing device 20C to prepare an electronic signature σ_1 from the signature key sk_1. The electronic signature σ_1 functions as a ticket validity certificate. The preparation of the electronic signature σ_1 from the signature key sk_1 may be performed by a device other than the ticket information processing device 20C.

Next, the user C uses the ticket information processing device 20C to record the ticket ID of the ticket T and the electronic signature σ_1 in the blockchain in association with each other.

The companies C, D, E, and F, which can confirm the blockchain, use the ticket validity confirmation devices 50C to 50F, respectively, to verify the electronic signature σ_1. During the verification, based on the ticket ID associated with the electronic signature σ_1, the verification key vk_1 associated with the same ticket ID is read from the blockchain. Then, the electronic signature σ_1 is verified by the verification key vk_1.

When the verified result indicates that the electronic signature σ_1 is valid, the ticket validity confirmation device 50C records, in a database of the resale information storage unit 523C, that the ticket T is in the want-to-resell state (want-to-resell state). The same operation is performed for the resale information storage units 523D to 523F of the ticket validity confirmation devices 50D to 50F.

In accordance with the update of the resale information in the resale information storage units 523C to 523F, the person managing the resale site of one of the companies C, D, E, and F sells the ticket T. When the existence of a ticket that has shifted to the want-to-resell state is detected based on monitoring of the resale information in the resale information storage units 523C to 523F, the control units 510C to 510F of the ticket validity confirmation devices 50C to 50F may display, on a display device (not shown), a message notifying of the existence of a ticket in the want-to-resell state.

It is assumed that at the resale site operated by the company D, the user D of the ticket information processing device 20D wants to purchase the ticket T. At this time, the ticket validity confirmation device 50D prepares a new electronic signature key pair for the ticket T. It is assumed that the new electronic signature key pair includes a signature key sk_2 and a verification key vk_2. In this case, the signature key sk_1 is different from the signature key sk_2, and the verification key vk_1 is different from the verification key vk_2.

The electronic signature key pair (signature key sk_1 and verification key vk_1) generated when the user C, who is the original purchaser, purchases the ticket T and the electronic signature key pair (signature key sk_2 and verification key vk_2) generated when the user D, who is the resale destination party, purchases the resold ticket T are both for the same ticket T.

However, the signature key ski and the signature key sk_2 are generated so as to be different from each other. Similarly, the verification key vk_1 and the verification key vk_2 are generated so as to be different from each other. In this way, in order to generate another key for the same ticket T, it is conceivable to generate the signature key and verification key based on the ticket ID and a time stamp of the date and time at which the generation processing is executed.

The ticket validity confirmation device 50D transmits, to the ticket information processing device 20D, the ticket ID of the ticket T and the signature key sk_2 in association with each other. The ticket validity confirmation device 50D records, in the valid ticket list on the blockchain, the ticket ID of the ticket T and the verification key vk_2 in association with each other.

<During Entry to Event>

For an event in which the user enters the site by using the ticket T, it is assumed that the company E manages entry into the event site. The user D, who is the resale destination party, is attempting to enter the event site. At this time, the user D inputs, to the ticket information processing device 20D, an instruction for indicating to the company E that he or she is a person who has purchased the ticket T in a genuine manner.

In response to this instruction, the ticket information processing device 20D generates an electronic signature σ_2 from the signature key sk_2. Next, the ticket information processing device 20D transmits, to the ticket validity confirmation device 50E of the company E, the ticket ID of the ticket T and the electronic signature σ_2 in association with each other.

The ticket validity confirmation device 50E reads, from the valid ticket list of the blockchain, the verification key vk_2 associated with the ticket ID of the ticket T. Then, the ticket validity confirmation device 50E uses the verification key vk_2 to verify the electronic signature σ_2. In this case, the electronic signature σ_2 is determined to be valid. When there are a plurality of signature keys registered in association with the same ticket ID in the valid ticket list on the blockchain, only the last registered signature key is treated as valid, and the other signatures are treated as being invalid.

In accordance with the determined result, the ticket validity confirmation device 50E displays, on the display device, a message indicating that the transmission source of the ticket ID and the electronic signature σ_2, that is, the ticket information processing device 20D, belongs to the user D, who is the valid right holder of the ticket. The person in charge at the company E sees this message, and permits the user D to enter the event site.

Meanwhile, when the ticket ID and the electronic signature transmitted to the ticket validity confirmation device 50E are incorrect, the ticket validity confirmation device 50E determines that the electronic signature is invalid. In accordance with this determined result, the ticket validity confirmation device 50E displays a message indicating that the transmission source is not that of the valid right holder. The person in charge at the company E sees this message, and denies the user D entry into the event site.

Even when the user C, who is the original purchaser, attempts to enter by using the ticket information processing device 20C, the ticket validity confirmation device 50E displays a message indicating that the transmission source is not that of the valid right holder. The electronic signature σ_1 generated by the ticket information processing device 20C is based on the signature key sk_1. As described above, the signature key ski is different from the signature key sk_2. In this case, it is assumed that the verification keys vk_1 and vk_2 are registered in the valid ticket list on the blockchain in association with the ticket ID of the ticket T. Even in this case, as described above, the valid verification key is only the last of the verification keys registered in association with the ticket ID, and therefore only the verification key vk_2 is valid. Therefore, the electronic signature σ_1 signed by the signature key sk_1 is verified based on the verification key vk_2. At this time, the ticket validity confirmation device 50E determines that the electronic signature σ_1 is invalid.

In this modification, whether or not a ticket belonging to the valid right holder is determined by using an electronic signature key pair as the certificate preparation information and the certificate verification information. This determination is based on the premise that the signature keys stored in the ticket information processing device 20 of the person trying to use the ticket are the electronic signature key pair of that person. Therefore, in order to more reliably determine whether or not the person using the ticket is the valid right holder, it is desired to confirm that the person is the valid holder of the electronic signature key pair. Specifically, for example, when the user of the ticket uses the ticket, it is preferred to confirm the identity of the person by requesting the user to present an identification card.

In the above-mentioned example embodiments and modification, the descriptions have been made on the assumption that the ticket information processing device 20 receives the certificate preparation information and prepares the ticket validity certificate. However, in place of this method, the ticket sales company or the like may deliver, by hand, to the ticket purchaser a piece of paper on which the certificate preparation information is written in natural language or as a barcode, for example.

In this case, the ticket purchaser uses a keyboard or the like while visually observing the certificate preparation information written on the ticket, and uses machine reading by using optical character recognition (OCR) or a barcode reader, to input the certificate preparation information to an information processing device corresponding to the ticket information processing device 20.

A part or a whole of the example embodiments described above may described as, but not limited to, the following supplementary notes.

(Supplementary Note 1)

A ticket validity confirmation device, comprising:

certificate data preparation means configured to prepare certificate data corresponding to one ticket, the certificate data comprising a set of certificate preparation information and certificate verification information;

verification information storage means configured to store the certificate verification information therein;

output means configured to externally output the certificate preparation information; and

certificate verification means configured to verify, based on the certificate verification information stored in the verification information storage means, a ticket validity certificate prepared by another device based on the certificate preparation information.

(Supplementary Note 2)

The ticket validity confirmation device according to Supplementary Note 1,

wherein the certificate data preparation means is configured to prepare, when one ticket is sold or resold, one piece of certificate data corresponding to the one ticket, and

wherein the one piece of certificate data corresponding to the same ticket is different for each sale or resale.

(Supplementary Note 3)

The ticket validity confirmation device according to Supplementary Note 1 or 2, further comprising certificate information communication means configured to transmit the certificate verification information to another ticket validity confirmation device,

wherein the certificate verification means is configured to verify the ticket validity certificate based on any one of the certificate verification information stored in the verification information storage means of the ticket validity confirmation device and the certificate verification information stored in the verification information storage means of the another ticket validity confirmation device.

(Supplementary Note 4)

The ticket validity confirmation device according to Supplementary Note 3,

wherein the certificate information communication means is configured to communicate with an information sharing server connected to a plurality of other ticket validity confirmation devices, and

wherein the ticket validity confirmation device is configured to perform communication relating to the certificate verification information to and from the plurality of other ticket validity confirmation devices via the information sharing server.

(Supplementary Note 5)

The ticket validity confirmation device according to any one of Supplementary Notes 1 to 4, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 6)

A ticket information processing device, comprising:

means configured to receive certificate preparation information of certificate data corresponding to one ticket prepared by a ticket validity confirmation device, the certificate data comprising a set of the certificate preparation information and certificate verification information;

means configured to prepare a ticket validity certificate based on the certificate preparation information; and

means configured to transmit the ticket validity certificate to the ticket validity confirmation device including a transmission source of the certificate preparation information,

the ticket information processing device being configured to receive, from the ticket validity confirmation device including the transmission source of the certificate preparation information, verification of the ticket validity certificate based on the certificate verification information.

(Supplementary Note 7)

The ticket information processing device according to Supplementary Note 6,

wherein the certificate data preparation means is configured to prepare, when one ticket is sold or resold, one piece of certificate data corresponding to the one ticket, and

wherein the one piece of certificate data corresponding to the same ticket is different for each sale or resale.

(Supplementary Note 8)

The ticket information processing device according to Supplementary Note 6 or 7, wherein the ticket information processing device is configured to receive verification of the ticket validity certificate based on the certificate verification information from the ticket validity confirmation device other than the transmission source of the certificate preparation information.

(Supplementary Note 9)

The ticket information processing device according to any one of Supplementary Notes 6 to 8, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 10)

A ticket validity confirmation system, comprising:

a ticket validity confirmation device; and

a ticket information processing device,

wherein the ticket validity confirmation device comprises:
certificate data preparation means configured to prepare certificate data corresponding to one ticket, the certificate data comprising a set of certificate preparation information and certificate verification information;
verification information storage means configured to store the certificate verification information therein;
output means configured to output the certificate preparation information to the ticket information processing device serving as a destination; and
certificate verification means configured to verify, based on the certificate verification information stored in the verification information storage means, a ticket validity certificate prepared by the ticket information processing device based on the certificate preparation information,

wherein the ticket information processing device comprises:
means configured to receive the certificate preparation information of the certificate data corresponding to one ticket prepared by the ticket validity confirmation device, the certificate data comprising a set of the certificate preparation information and the certificate verification information;
means configured to prepare the ticket validity certificate based on the certificate preparation information; and
means configured to transmit the ticket validity certificate to the ticket validity confirmation device including a transmission source of the certificate preparation information.

(Supplementary Note 11)

The ticket validity confirmation system according to Supplementary Note 10,

wherein the certificate data preparation means is configured to prepare, when one ticket is sold or resold, one piece of certificate data corresponding to the one ticket, and

wherein the one piece of certificate data corresponding to the same ticket is different for each sale or resale.

(Supplementary Note 12)

The ticket validity confirmation system according to Supplementary Note 10 or 11, wherein the ticket validity confirmation device further comprises certificate information communication means configured to transmit the certificate verification information to another ticket validity confirmation device,

wherein the certificate verification means is configured to verify the ticket validity certificate based on any one of the certificate verification information stored in the verification information storage means of the ticket validity confirmation device and the certificate verification information stored in the verification information storage means of the another ticket validity confirmation device.

(Supplementary Note 13)

The ticket validity confirmation system according to Supplementary Note 12, further including:

a plurality of the ticket validity confirmation devices; and

an information sharing server connected to each of the plurality of ticket validity confirmation devices,

wherein the certificate information communication means is configured to communicate with the information sharing server, and

wherein each of the plurality of ticket validity confirmation devices is configured to perform communication relating to the certificate verification information to and from another of the plurality of ticket validity confirmation devices via the information sharing server.

(Supplementary Note 14)

The ticket validity confirmation system according to any one of Supplementary Notes 10 to 13, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 15)

A method to be executed by a ticket validity confirmation device, the method comprising:

a certificate data preparation step of preparing certificate data corresponding to one ticket, the certificate data comprising a set of certificate preparation information and certificate verification information;

a verification information storage step of storing the certificate verification information in a storage device;

an output step of externally outputting the certificate preparation information; and

a certificate verification step of verifying, based on the certificate verification information stored in the storage device, a ticket validity certificate prepared by another device based on the certificate preparation information.

(Supplementary Note 16)

The method according to Supplementary Note 15,

wherein, when one ticket is sold or resold, the certificate data preparation step is executed to prepare one piece of certificate data corresponding to the one ticket, and

wherein the one piece of certificate data corresponding to the same ticket is different for each sale or resale.

(Supplementary Note 17)

The method according to Supplementary Note 15 or 16, further comprising a certificate information communication step for transmitting the certificate verification information to another ticket validity confirmation device,

wherein the certificate verification step verifies the ticket validity certificate based on any one of the certificate verification information stored in the storage device of the ticket validity confirmation device and the certificate verification information stored in a storage device of the another ticket validity confirmation device.

(Supplementary Note 18)

The method according to Supplementary Note 17,

wherein the certificate information communication step communicates with an information sharing server connected to a plurality of other ticket validity confirmation devices, and

wherein the ticket validity confirmation device performs communication relating to the certificate verification information to and from the plurality of other ticket validity confirmation devices via the information sharing server.

(Supplementary Note 19)

The method according to any one of Supplementary Notes 15 to 18, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 20)

A method to be executed by a ticket information processing device, the method comprising the steps of:

receiving, by the ticket information processing device, certificate preparation information of certificate data corresponding to one ticket prepared by a ticket validity confirmation device, the certificate data comprising a set of the certificate preparation information and certificate verification information;

preparing, by the ticket information processing device, a ticket validity certificate based on the certificate preparation information; and

transmitting, from the ticket information processing device, the ticket validity certificate to the ticket validity confirmation device including a transmission source of the certificate preparation information,

wherein the ticket information processing device receives, from the ticket validity confirmation device including the transmission source of the certificate preparation information, verification of the ticket validity certificate based on the certificate verification information.

(Supplementary Note 21)

The method according to Supplementary Note 20,

wherein, when one ticket is sold or resold, one piece of certificate data corresponding to the one ticket is received, and

wherein the one piece of certificate data corresponding to the same ticket is different for each sale or resale.

(Supplementary Note 22)

The method according to Supplementary Note 20 or 22, wherein verification of the ticket validity certificate based on the certificate verification information is received from the ticket validity confirmation device other than the transmission source of the certificate preparation information.

(Supplementary Note 23)

The method according to any one of Supplementary Notes 20 to 22, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 24)

A method of confirming a validity of a ticket, the method comprising the steps of: preparing, by a ticket validity confirmation device configured to confirm a validity of a ticket, certificate data corresponding to one ticket, the certificate data comprising a set of certificate preparation information and certificate verification information;

storing, by the ticket validity confirmation device, the certificate verification information in a storage device;

outputting the certificate preparation information from the ticket validity confirmation device to the ticket information processing device as a destination;

receiving, by the ticket information processing device, the certificate preparation information;

preparing, by the ticket information processing device, the ticket validity certificate based on the certificate preparation information;

outputting, by the ticket information processing device, the ticket validity certificate to the ticket validity confirmation device as a destination;

receiving, by the ticket validity confirmation device, the ticket validity certificate; and

verifying, by the ticket validity confirmation device, the ticket validity certificate based on the certificate verification information stored in the storage device.

(Supplementary Note 25)

The method according to Supplementary Note 24,

wherein the certificate data preparation means is configured to prepare, when one ticket is sold or resold, one piece of certificate data corresponding to the one ticket, and

wherein the one piece of certificate data corresponding to the same ticket is different for each sale or resale.

(Supplementary Note 26)

The method according to Supplementary Note 24 or 25, further comprising a certificate information communication step of transmitting, from the ticket validity confirmation device, the certificate verification information to another ticket validity confirmation device,

wherein the certificate verification step verifies the ticket validity certificate based on any one of the certificate verification information stored in the verification information storage means of the ticket validity confirmation device and the certificate verification information stored in the verification information storage means of the another ticket validity confirmation device.

(Supplementary Note 27)

The method according to Supplementary Note 26,

wherein each of the plurality of ticket validity confirmation devices is connected to an information sharing server, and

wherein each of the plurality of ticket validity confirmation devices performs communication relating to the certificate verification information to and from another of the plurality of ticket validity confirmation devices via the information sharing server.

(Supplementary Note 28)

The method according to any one of Supplementary Notes 24 to 27, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 29)

A program for causing a computer to operate as:

certificate data preparation means for preparing certificate data corresponding to one ticket, the certificate data comprising a set of certificate preparation information and certificate verification information;

verification information storage means for storing the certificate verification information therein;

output means for externally outputting the certificate preparation information; and

certificate verification means for verifying, based on the certificate verification information stored in the verification information storage means, a ticket validity certificate prepared by another device based on the certificate preparation information.

(Supplementary Note 30)

The program according to Supplementary Note 29,

wherein the certificate data preparation means is configured to prepare, when one ticket is sold or resold, one piece of certificate data corresponding to the one ticket, and

wherein the one piece of certificate data corresponding to the same ticket is different for each sale or resale.

(Supplementary Note 31)

The program according to Supplementary Note 29 or 30, the program causing the computer to further operate as certificate information communication means for transmitting the certificate verification information to another ticket validity confirmation device,

wherein the certificate verification means is configured to verify the ticket validity certificate based on any one of the certificate verification information stored in the verification information storage means of the ticket validity confirmation device and the certificate verification information, which is received via the certificate information communication means, stored in the verification information storage means of the another ticket validity confirmation device.

(Supplementary Note 32)

The program according to Supplementary Note 31,

wherein the certificate information communication means is configured to communicate with an information sharing server connected to a plurality of other ticket validity confirmation devices, and

wherein the computer performs communication relating to the certificate verification information to and from the plurality of other ticket validity confirmation devices via the information sharing server.

(Supplementary Note 33)

The program according to any one of Supplementary Notes 29 to 32, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

(Supplementary Note 34)

A program causing a computer to operate as:

means for receiving certificate preparation information of certificate data corresponding to one ticket prepared by a ticket validity confirmation device, the certificate data comprising a set of the certificate preparation information and certificate verification information;

means for preparing a ticket validity certificate based on the certificate preparation information; and

means for transmitting the ticket validity certificate to the ticket validity confirmation device including a transmission source of the certificate preparation information, wherein the program causes the computer to receive, from the ticket validity confirmation device including the transmission source of the certificate preparation information, verification of the ticket validity certificate based on the certificate verification information.

(Supplementary Note 35)

The program according to Supplementary Note 34,

wherein the certificate data preparation means is configured to prepare, when one ticket is sold or resold, one piece of certificate data corresponding to the one ticket, and

wherein the one piece of certificate data corresponding to the same ticket is different for each sale or resale.

(Supplementary Note 36)

The program according to Supplementary Note 34 or 35, wherein the computer receives verification of the ticket validity certificate based on the certificate verification information from the ticket validity confirmation device other than the transmission source of the certificate preparation information.

(Supplementary Note 37)

The program according to any one of Supplementary Notes 34 to 36, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

### REFERENCE SIGNS LIST

10, 30, 50, 50C to 50F ticket validity confirmation device
20, 20C to 20F ticket information processing device
21 communication unit
22 control unit
23 storage device
24 display unit
70 information sharing server
80 network
110, 310, 510, 710 control unit
111, 311, 511 certificate data preparation unit
112, 312, 512 certificate verification unit
120, 320, 520, 720 storage unit
121, 321, 521, 721 verification information storage unit
122, 322, 522, 722 usage history storage unit
130, 330, 530, 730 communication unit
131, 331, 531 certificate information communication unit
323 resale information storage unit
532, 731 shared information communication unit

What is claimed is:

1. A ticket validity confirmation device, comprising:
a certificate data preparation unit configured to prepare certificate data corresponding to one ticket, the certificate data comprising a set of certificate preparation information and certificate verification information;
a verification information storage unit configured to store the certificate verification information therein;
an output unit configured to externally output the certificate preparation information; and
a certificate verification unit configured to verify, based on the certificate verification information stored in the verification information storage, unit, a ticket validity certificate prepared by another device based on the certificate preparation information.

2. The ticket validity confirmation device according to claim 1,
wherein the certificate data preparation unit is configured to prepare, when one ticket is sold or resold, one piece of certificate data corresponding to the one ticket, and
wherein the one piece of certificate data corresponding to the same ticket is different for each sale or resale.

3. The ticket validity confirmation device according to claim 1, further comprising a certificate information communication unit configured to transmit the certificate verification information to another ticket validity confirmation device,
wherein the certificate verification unit is configured to verify the ticket validity certificate based on any one of the certificate verification information stored in the verification information storage unit of the ticket validity confirmation device and the certificate verification information stored in the verification information storage unit of the another ticket validity confirmation device.

4. The ticket validity confirmation device according to claim 3,
wherein the certificate information communication unit is configured to communicate with an information sharing server connected to a plurality of other ticket validity confirmation devices, and
wherein the ticket validity confirmation device is configured to perform communication relating to the certificate verification information to and from the plurality of other ticket validity confirmation devices via the information sharing server.

5. The ticket validity confirmation device according to claim 1, wherein the certificate data is an electronic signature key pair, wherein the certificate preparation information is a signature key of the electronic signature key pair, wherein the certificate verification information is a verification key of the electronic signature key pair, and wherein the ticket validity certificate is an electronic signature signed with the signature key.

6. A ticket information processing device, comprising:
a receiving unit configured to receive certificate preparation information of certificate data corresponding to one ticket prepared by a ticket validity confirmation device, the certificate data comprising a set of the certificate preparation information and certificate verification information;
a preparing unit configured to prepare a ticket validity certificate based on the certificate preparation information; and
a transmitting unit configured to transmit the ticket validity certificate to the ticket validity confirmation device including a transmission source of the certificate preparation information,
the ticket information processing device being configured to receive, from the ticket validity confirmation device including the transmission source of the certificate preparation information, verification of the ticket validity certificate based on the certificate verification information.

7. A ticket validity confirmation system, comprising:
a ticket validity confirmation device; and
a ticket information processing device,
wherein the ticket validity confirmation device comprises:
a certificate data preparation unit configured to prepare certificate data corresponding to one ticket, the certificate data comprising a set of certificate preparation information and certificate verification information;
a verification information storage unit configured to store the certificate verification information therein;
an output unit configured to output the certificate preparation information to the ticket information processing device serving as a destination; and
a certificate verification unit configured to verify, based on the certificate verification information stored in the verification information storage unit, a ticket validity certificate prepared by the ticket information processing device based on the certificate preparation information,
wherein the ticket information processing device comprises:
a receiving unit configured to receive the certificate preparation information of the certificate data corresponding to one ticket prepared by the ticket validity confirmation device;
a preparing unit configured to prepare the ticket validity certificate based on the certificate preparation information; and
a transmitting unit configured to transmit the ticket validity certificate to the ticket validity confirmation device including a transmission source of the certificate preparation information.

8.-10. (canceled)

11. The ticket information processing device according to claim 6,
wherein the receiving unit is configured to receive, when one ticket is sold or resold, one piece of certificate data corresponding to the one ticket, and
wherein the one piece of certificate data corresponding to the same ticket is different for each sale or resale.

12. The ticket information processing device according to claim 6, wherein the ticket information processing device is configured to receive verification of the ticket validity certificate based on the certificate verification information from the ticket validity confirmation device other than the transmission source of the certificate preparation information.

13. The ticket information processing device according to claim 6,
wherein the certificate data is an electronic signature key pair,
wherein the certificate creation information is a signature key of the electronic signature key pair,
wherein the certificate verification information is a verification key of the electronic signature key pair, and
wherein the ticket validity certificate is an electronic signature signed with the signature key.

14. The ticket validity confirmation system according to claim 7,
wherein the certificate data preparation unit is configured to prepare, when one ticket is sold or resold, one piece of certificate data corresponding to the one ticket, and
wherein the one piece of certificate data corresponding to the same ticket is different for each sale or resale.

15. The ticket validity confirmation system according to claim 7, wherein the ticket validity confirmation device further comprises a certificate information communication unit configured to transmit the certificate verification information to another ticket validity confirmation device,
wherein the certificate verification unit is configured to verify the ticket validity certificate based on any one of the certificate verification information stored in the verification information storage unit of the ticket validity confirmation device and the certificate verification information stored in the verification information storage unit of the another ticket validity confirmation device.

16. The ticket validity confirmation system according to claim 15, further including:
the plurality of ticket validity confirmation devices; and
an information sharing server connected to each of the plurality of ticket validity confirmation devices,
wherein the certificate information communication means is configured to communicate with the information sharing server, and
wherein each of the plurality of ticket validity confirmation devices is configured to perform communication relating to the certificate verification information to and from another of the plurality of ticket validity confirmation devices via the information sharing server.

17. The ticket validity confirmation system according to claim 7,
wherein the certificate data is an electronic signature key pair,
wherein the certificate creation information is a signature key of the electronic signature key pair,
wherein the certificate verification information is a verification key of the electronic signature key pair, and
wherein the ticket validity certificate is an electronic signature signed with the signature key.
